(19) United States
(12) Patent Application Publication
(10) Pub. No.: US 2007/0005364 A1
(43) Pub. Date: Jan. 4, 2007

(54) Pure phonetic orthographic system

(76) Inventor: Hesley Howard DeBow, Huntsville, AL (US)

Correspondence Address: HESLEY H. DEBOW, 1008 BRISBANE LANE, HUNTSVILLE, AL, 35803, US

(21) Appl. No.: 11/170,014

(22) Filed: Jun. 29, 2005

(51) Int. Cl. G10L 13/08

(52) U.S. Cl. 704/260

(57) ABSTRACT

This invention is utility in nature. It assigns one and only one sound to each Arabic character. It has the purpose of making words easy to spell and read. There are no exceptions in the “Pure Phonetic Orthographic System”. Once a child or adult learns the sound of each character and blend as assigned in the Pure Phonetic Orthographic System, he/she will be able to read and spell to near perfection. The current English system of spelling was developed haphazardly and is illogical in its nature. The “Pure Phonetic Orthographic System” is precise and logical. It is not meant as an adjunct to help people read using our current illogical system. This invention is meant to totally replace the current system in all written English in the United States.

### CROSS-REFERENCE TO RELATED APPLICATIONS

N/A

### STATEMENT REGARDING FEDERALLY SPONSORED RESEARCH OR DEVELOPMENT

NA

### REFERENCE TO SEQUENCE LISTING, A TABLE, OR A COMPUTER PROGRAM LISTING COMPACT DISK APPENDIX.

NA

### BACKGROUND OF THE INVENTION

This invention relates to how words are spelled in the English language. Anyone who attempts to read words as they are now spelled in the English language finds it difficult to acquire the skills to become an efficient reader. Numerous researches into methods of teaching reading have failed to provide an efficient solution to this problem.

### SUMMARY OF THE INVENTION

This invention lays out a pure phonetic orthographic system that is meant to completely replace the way words are spelled in the United States. It is envisioned that all dictionaries, books, signs, names, and other written materials will eventually be printed using this new system of spelling. This invention calls for all letters of the alphabet to be named by their sound. It provides exactly one and only one sound for each alphabetic character. Because some letters are redundant to others, those letters will be assigned totally different sounds from their current use. Those letters are “c”, “q”, and “x”. This orthographic system will contain fourteen vowels and nineteen consonants. The primary purpose for this invention is to aid children and adults, foreign or U.S. to read. It is envisioned that upon conversion and to begin implementation all books for all beginning kindergartners will be printed using this pure phonics system. By the time these kindergarteners reach the 12^{th} grade, all public school books will have been converted to the pure phonetic orthographic system and this country will have a school population literacy rate that approaches 100%. In addition, nearly all adults, with a little study of this pure phonetic orthographic system will be good readers. Reading programs and the massive spending on reading improvement as is current in this country will vanish.

### DETAILED DESCRIPTION OF THE INVENTION

This invention consists of a modification of how some of the Arabic characters are named and pronounced and how they are to be used to precisely define the sounds that they make when they are pronounced. The sounds which are being assigned to each character are identified. Each character is assigned a sound. The sound assigned to each character or combination of characters is set and is unchangeable.

This invention sets fourteen vowels; seven long vowels and seven short vowels. The short vowels are obtained by placing a diacritical accent mark above the long vowel.

This invention sets nineteen consonants. The consonants are identified as to their sounds for beginning words, internally in the words, and ending words. Unless identified otherwise in the assignment below, each consonant will have the same sound regardless of its position in the word. Except for the consonant “q” all consonants will have the same sound as they are currently used in Webster's New American Dictionary, 1995 edition. The character “q” will be given the sound currently assigned to “sh” as in the current spelling of “show” and “wish”. For instance, the word that is now currently spelled “show” will be spelled “qo” and the word “wish” will be spelled “wíq” (Note the diacritic mark above the “i” to produce the short sound).

Arabic characters will no longer have names that are different from their sounds. The sound of the character will be the character's name.

This invention has no bearing on how upper or lower case letters are formed, i.e. it does not change any fonts, either upper case or lower case.

The character assignments and sounds of each character will be as follows in the pure phonetic orthographic system. To facilitate understanding, vowels are listed showing how they are currently used in words and how they will be used in the pure phonetic orthographic system. In order to have the needed number of vowels, diacritical accent marks have been used to change the long vowels to their short counterparts. “c” and “x” are not needed as consonants in this true phonetic system. All vowel and consonant sounds are as shown below:

| Long Vowels | | | Short Vowels | | |
|---|---|---|---|---|---|
| | Current | New | | Current | |
| | Spelling | Spelling | | Spelling | New |
| Characters | & Sound | & Sound | Character | & Sound | Spelling |
| a | say | sa | á | sat | sát |
| c | saw | sc | ć | cow | kć |
| e | be | be | é | set | sét |
| i | by | bi | í | sit | sít |
| o | no | no | ó | not | nót |
| u | sue | su | ú | foot | fút |

| | | | | |
|---|---|---|---|---|
| x | cup | kxp | \acute{x} | not yet assigned |
| | | | | a sound |

Consonents

b-beginning and ending sound as in “bob

d-beginning and ending sound as in “dad”

f-beginning and ending sound as in “fife”

g-beginning and ending sound as in “gong”

h-beginning sound as in “hare”, not used as an ending sound

J-Beginning and ending sound as in “judge”

k-beginning and ending sound as in “kook”

l-beginning and ending sound as in “lull”

m-beginning and ending sound as in “mom”

n-beginning and ending sound as in “noon”

p-beginning and ending sound as in “pop”

q-beginning and ending sound as in “shush”

r-beginning and ending sound as in “rear”

s-beginning and ending sound as in “sass”

t-beginning and ending sound as in “tot”

w-beginning sound as in “woke”, not used as an ending sound

v-beginning and ending sound as in valve

y-beginning sound as in “yoke”, not used as an ending sound

z-beginning and ending sound as in “zaz”

Blends

Except for the blends “ch” and “th”, the blends have not changed from our current use of blends and are as follows: bl, br, bw, by, dr, dw, dy, fl, fr, fy, gl, gr, gw, jm, jr, kl, kr, kw, ky, pl, pr, sf, sk, sl, sn, sm, sp, st, sw, th, thh, tr, tw, wh, sjr, skr, spl, spr, str, the new jh to replace ch. Th, though not a true blend will remain unchanged except the hard (exasperated). The hard sound of th will be spelled thh. Therefore, thhr, thhw are blends using thh. *Q” will be given a new sound and name. It will be used to replace our current “sh” sound. As an example, the word “show” (current way to spell it) will be spelled “qo” (pure phonetics' way of spelling it)'

1. This invention assigns a unique and specific sound (phoneme) to each alphabetic character.

2. Each sound in the U.S. English language will be represented by one and only one alphabet character or combination of alphabet characters.

3. Each alphabetic character or combination of characters will have one and only one sound associated with that character or combination of characters.

4. This system of spelling contains thirty-three characters.

5. This system of spelling contains nineteen consonant characters

6. The system of spelling contains fourteen vowel characters.

7. Seven of the vowel sounds are developed from the five current vowels plus two former consonant characters.

9. Seven of the vowels sounds are developed by the use of diacritical marks.

10. The fourteen alphabetic characters that will serve as vowels are as follows:
a. The vowels will consist of seven unmarked characters and seven marked characters.
b. The unmarked characters will be a, e, i, o, u, c, and x.
c. The marked characters will be á, ć, é, í, ó, ú, and \acute{x}.

11. Each vowel will have its own particular sound and will always be pronounced with that particular sound.

12. The vowel sounds will be as follows:
a. “a” as the “a” in mate
b. “c” as the “aw” in saw
c. “e” as the “ee” in meet
d. “i” as the “i” in bite
e. “o” as the “o” in in no
f. “u” as the “ u” in flute
g. “x: as the “u” in cup
h. “á” as the “a” in cat
i. “ć” as the “ow” in cow
j. “é” as the “e” in set
k. “í” as the “i” in sit
l. “ó” as the “o” in not
m. “ú” as the “oo” in foot
n. “\acute{x}” is currently unassigned.

13. The consonant sounds will be as follows:
“b”-beginning and ending sound as in “bob
“d”-beginning and ending sound as in “dad”
“f”-beginning and ending sound as in “fife”
“g”-beginning and ending sound as in “gong”
“h-beginning sound as in “hare”, not used as an ending sound
“j”-Beginning and ending sound as in “judge”
“k”-beginning and ending sound as in “kook”
“l”-beginning and ending sound as in “lull”
“m”-beginning and ending sound as in “mom”
“n”-beginning and ending sound as in “noon”
“p”-beginning and ending sound as in “pop”
“q”-beginning and ending sound as in “shush”
“r”-beginning and ending sound as in “rear”
“s”-beginning and ending sound as in “sass”
“t”-beginning and ending sound as in “tot”
“v”-beginning and ending sound as in “valve”
“w”-beginning sound as in “way”
“y”-beginning sound as in “yes”
“z”-Beginning and ending sound as in zaz”

14. There will be no use of vowels or consonants as silent fillers.

15. The phonemes will make use of blended consonants. Each blend of consonants will always represent a specific peculiar sound and are as follows:

16. Words that are currently spelled illogically will in the be spelled precisely and logically. For instance: “psychology” will be spelled “sikólxje”, the word “phonics” will be spelled “fxníks”, and the words “you, zoo, and two” will be spelled “yu, zu, and tu”, respectively.
Blends: bl, br, bw, by, dr, dw, dy, fi, fr, fy, gl, gr, gw, jm, jr, kl, kr, kw, ky, pl, pr, sf, sk, sl, sn, sm, sp, st, sw, th, thh, tr, tw, wh, sjr, skr, spl, spr, str, the new jh to replace ch. Th, though not a true blend will remain unchanged except the hard (exasperated). The hard sound of th will be spelled thh. Therefore, thhr, thhw are blends using thh.

17. Where two consonants are adjacent and do not represent a particular blend, they will be separated by a dash.
a. For instance, the word muskrat will be written musk-rat.(old spelling-new true phonics spelling will be mxsk-rát)
